(19) United States
(12) Patent Application Publication
(10) Pub. No.: US 2014/0123114 A1
(43) Pub. Date: May 1, 2014

(54) FRAMEWORK FOR INTEGRATION AND EXECUTION STANDARDIZATION (FIESTA)

(71) Applicants: Asif Iqbal Navalur, Bangalore (IN); Suresh Kumar Yalla, Bangalore (IN)

(72) Inventors: Asif Iqbal Navalur, Bangalore (IN); Suresh Kumar Yalla, Bangalore (IN)

(73) Assignee: SAP AG, Walldorf (DE)

(21) Appl. No.: 13/660,824

(22) Filed: Oct. 25, 2012

(51) Int. Cl. G06F 11/36

(52) U.S. Cl. 717/127

(57) ABSTRACT

A framework for end-to-end scenario-level automated testing of a multi-technology application. Execution of end-to-end automated testing of a multi-technology application is triggered from a single platform on a local client machine, The end-to-end automated test comprises a plurality of tests each developed from a different testing tool. Test result data is received from the execution of the tests. Test result data is passed from the execution of one of the tests to a different test for use in the execution of the different test. A log of results is generated for the end-to-end automated testing of the multi-technology application based on the received test result data from the execution of the plurality of tests. In some embodiments, execution of a test on a back-end system is triggered from the single platform on the local client machine. In some embodiments, the back-end system is an ABAP back-end system.

### TECHNICAL FIELD

The present application relates generally to the technical field of test automation, and, in one specific example, to end-to-end scenario-level automated testing of multi-technology applications.

### BACKGROUND

Today, applications are developed by integrating different products that have been developed using different technologies. Since each product has its own test automation tool(s), one complete end-to-end scenario-level testing of a multi-technology application uses multiple test automation tools, as using only one tool for testing is difficult and not reliable. Additionally, current solutions are server-based, requiring extensive overhead and maintenance.

### BRIEF DESCRIPTION OF THE DRAWINGS

Some embodiments are illustrated by way of example and not limitation in the figures of the accompanying drawings in which:

FIG. 1 is a network diagram illustrating a client-server system, within which an example embodiment can be deployed.

FIG. 2 is a block diagram illustrating enterprise applications and services as embodied in an example embodiment of an enterprise application platform.

FIG. 3 is a block diagram illustrating an example embodiment of a system that provides a framework for end-to-end automated testing of a multi-technology application.

FIG. 4 is a flowchart illustrating an example embodiment of a method for end-to-end test automation of a multi-technology application.

FIG. 5 is a flowchart illustrating an example embodiment of a method for end-to-end testing of a multi-technology application.

FIG. 6 is a block diagram of an example computer system on which methodologies described herein may be executed.

### DETAILED DESCRIPTION

Example methods and systems for a test automation framework for end-to-end scenario-level automated testing of multi-technology applications are described. In the following description, for purposes of explanation, numerous specific details are set forth in order to provide a thorough understanding of example embodiments. It will be evident, however, to one skilled in the art that the present embodiments may be practiced without these specific details.

Organizations can increase day-to-day operations and help the bottom line by integrating and standardizing the process of quality assurance, which enables organizations to reduce costs and further benefit from their investments in enterprise solutions. The embodiments of present invention provide one central client-based system acting as the starting point for all automated test executions. In some embodiments, the test framework of the present embodiments does not make use of any server or database for processing the test automation jobs. Instead, it uses a light-weight plug-in, which is installed in the job-triggering client system. As a result, the overhead of server/database maintenance is removed, as the processes are performed on the client itself. Unit tests, user interface tests, and integration tests can be managed using the same execution platform. Furthermore, data can be transferred between tests that are developed using different test tools. Additionally, in some of its embodiments, the present disclosure provides an open-ended test automation framework, thereby enabling a user to add test tools and create his own test logic. The embodiments of the present disclosure also provide easy integration with common test management systems and environments.

In some embodiments of a framework for end-to-end scenario-level automated testing of a multi-technology application, execution of an end-to-end automated testing of the multi-technology application may be triggered from a single platform on a local client machine. The end-to-end automated testing may comprise a plurality of tests each developed from a different testing tool. Test result data may be received from the execution of the tests. Test result data may be passed from the execution of one of the tests to a different test for use in the execution of the different test. A log of results may be generated for the end-to-end automated testing of the multi-technology application based on the received test result data from the execution of the plurality of tests.

In some embodiments, a testing tool from which to develop one of the tests may be determined on the local client machine. In some embodiments, test logic for use in execution of at least one of the plurality of tests may be created on the local client machine. In some embodiments, the execution of the plurality of tests may be performed on the local client machine. In some embodiments, the execution of the plurality of tests may be performed on a remote client machine. In some embodiments, execution of a test on a back-end system may be triggered on the single platform on the local client machine. In some embodiments, the back-end system may be an ABAP back-end system. In some embodiments, triggering the execution of the end-to-end testing may involve a driver on the client machine sending a test request to an adapter on the client machine. The test request may correspond to one of the tests. The adapter may determine a testing tool plug-in that corresponds to the one of the tests. The adapter may then invoke the testing tool plug-in for use in the execution of the one of the tests.

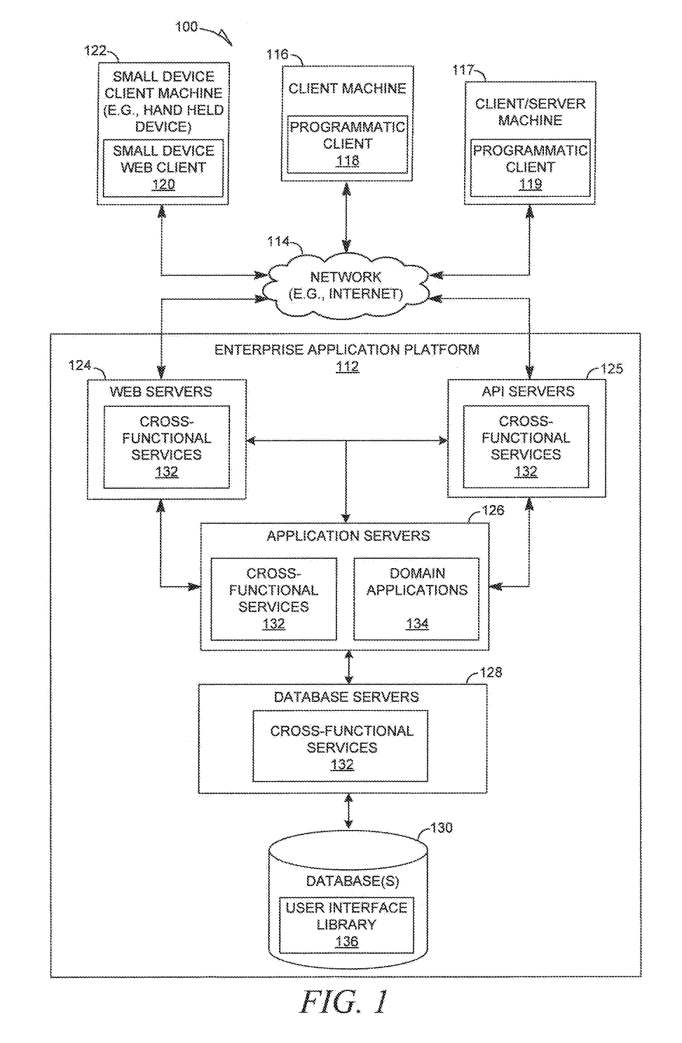

FIG. 1 is a network diagram depicting a system 100, according to one exemplary embodiment, having a client-server architecture. A platform (e.g., machines and software), in the exemplary form of an enterprise application platform 112, provides server-side functionality, via a network 114 (e.g., the Internet) to one or more clients. FIG. 1 illustrates, for example, a client machine 116 with programmatic client 118 (e.g., a browser, such as the INTERNET EXPLORER browser developed by Microsoft Corporation of Redmond, Wash. State), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 may be coupled to, and provide web and programmatic interfaces to, application servers 126. The application servers 126 may be, in turn, coupled to one or more database servers 128 that facilitate access to one or more databases 130. The web servers 124, Application Program Interface (API) servers 125, application servers 126, and database servers 128 may host cross-functional services 132. The application servers 126 further may host domain applications 134.

The cross-functional services 132 provide services to users and processes that utilize the information enterprise application platform 112. For instance, the cross-functional services 132 may provide portal services (e.g., web services), database services and connectivity to the domain applications 134 for users that operate the client machine 116, the client/server machine 117 and the small device client machine 122. In addition, the cross-functional services 132 may provide an environment for delivering enhancements to existing applications and for integrating third-party and legacy applications with existing cross-functional services 132 and domain applications 134. Further, while the system 100 shown in FIG. 1 employs a client-server architecture, the embodiments of the present invention are of course not limited to such an architecture, and could equally well find application in a distributed, or peer-to-peer, architecture system.

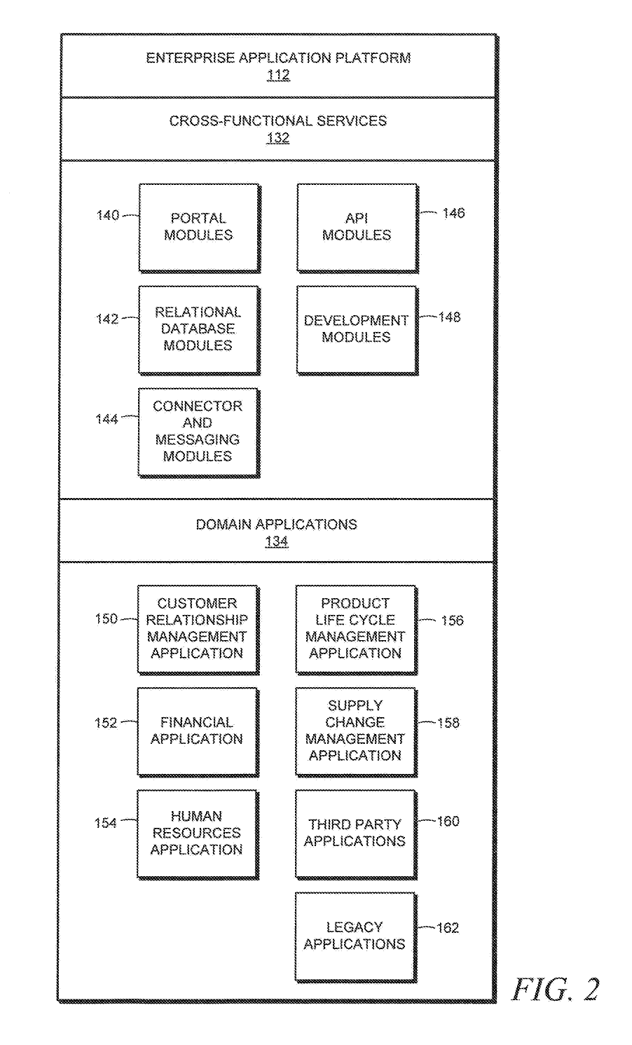

FIG. 2 is a block diagram illustrating enterprise applications and services as embodied in the enterprise application platform 112, according to an exemplary embodiment. The enterprise application platform 112 includes cross-functional services 132 and domain applications 134. The cross-functional services 132 may include portal modules 140, relational database modules 142, connector and messaging modules 144, Application Program Interface (API) modules 146, and development modules 148.

The portal modules 140 may enable a single point of access to other cross-functional services 132 and domain applications 134 for the client machine 116, the small device client machine 122 and the client/server machine 117. The portal modules 140 may be utilized to process, author and maintain web pages that present content (e.g., user interface elements and navigational controls) to the user. In addition, the portal modules 140 may enable user roles, a construct that associates a role with a specialized environment that is utilized by a user to execute tasks, utilize services and exchange information with other users and within a defined scope. For example, the role may determine the content that is available to the user and the activities that the user may perform. The portal modules 140 include a generation module, a communication module, a receiving module and a regenerating module. In addition the portal modules 140 may comply with web services standards and/or utilize a variety of Internet technologies including Java, J2EE, SAP's Advanced Business Application Programming Language (ABAP) and Web Dynpro, XML, JCA, JAAS, X.509, LDAP, WSDL, WSRR, SOAP, UDDI and Microsoft .NET.

The relational database modules 142 may provide support services for access to the database 130, which includes a user interface library 136. The relational database modules 142 may provide support for object relational mapping, database independence and distributed computing. The relational database modules 142 may be utilized to add, delete, update and manage database elements. In addition, the relational database modules 142 may comply with database standards and/or utilize a variety of database technologies including SQL, SQLDBC, Oracle, MySQL, Unicode, JDBC.

The connector and messaging modules 144 may enable communication across different types of messaging systems that are utilized by the cross-functional services 132 and the domain applications 134 by providing a common messaging application processing interface. The connector and messaging modules 144 may enable asynchronous communication on the enterprise application platform 112.

The Application Program Interface (API) modules 146 may enable the development of service-based applications by exposing an interface to existing and new applications as services. Repositories may be included in the platform as a central place to find available services when building applications.

The development modules 148 may provide a development environment for the addition, integration, updating and extension of software components on the enterprise application platform 112 without impacting existing cross-functional services 132 and domain applications 134.

Turning to the domain applications 134, the customer relationship management application 150 may enable access to and may facilitate collecting and storing of relevant personalized information from multiple data sources and business processes. Enterprise personnel that are tasked with developing a buyer into a long-term customer may utilize the customer relationship management applications 150 to provide assistance to the buyer throughout a customer engagement cycle.

Enterprise personnel may utilize the financial applications 152 and business processes to track and control financial transactions within the enterprise application platform 112. The financial applications 152 may facilitate the execution of operational, analytical and collaborative tasks that are associated with financial management. Specifically, the financial applications 152 may enable the performance of tasks related to financial accountability, planning, forecasting, and managing the cost of finance.

The human resource applications 154 may be utilized by enterprise personal and business processes to manage, deploy, and track enterprise personnel. Specifically, the human resource applications 154 may enable the analysis of human resource issues and facilitate human resource decisions based on real time information.

The product life cycle management applications 156 may enable the management of a product throughout the life cycle of the product. For example, the product life cycle management applications 156 may enable collaborative engineering, custom product development, project management, asset management and quality management among business partners.

The supply chain management applications 158 may enable monitoring of performances that are observed in supply chains. The supply chain management applications 158 may facilitate adherence to production plans and on-time delivery of products and services.

The third-party applications 160, as well as legacy applications 162, may be integrated with domain applications 134 and utilize cross-functional services 132 on the enterprise application platform 112.

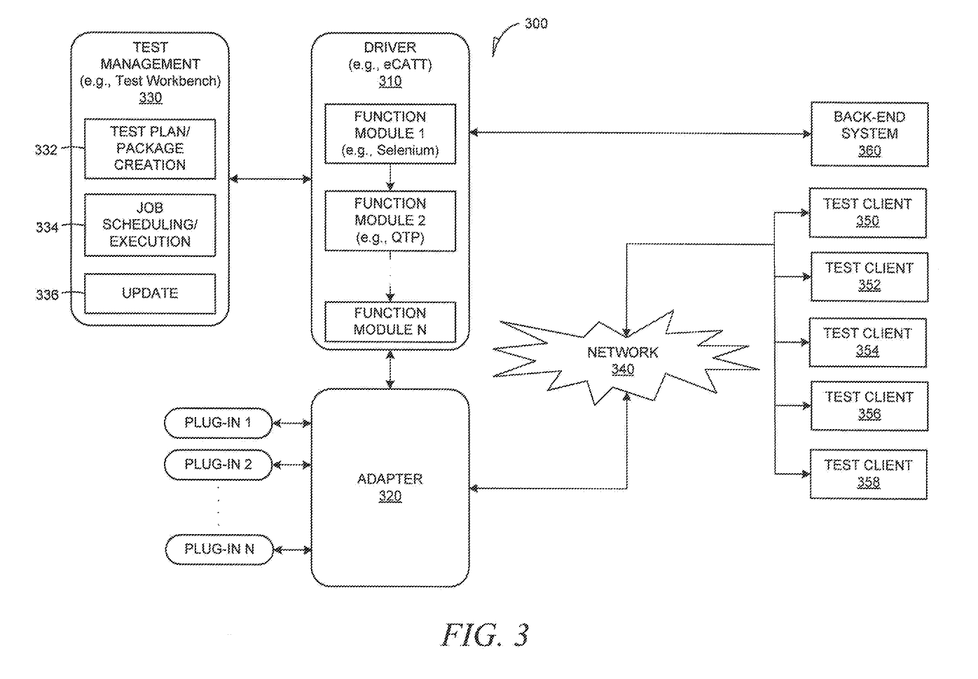

FIG. 3 is a block diagram illustrating one example embodiment of a system 300 that provides a framework for end-to-end scenario-level automated testing of a multi-technology application. The framework may be implemented on a local client machine using a driver 310 and an adapter 320. The driver 310 may be configured to initiate requests for test automation tools by triggering the adapter 320 to invoke a testing tool in either the local client machine or in one or more remote test clients 350-358 via a network 340.

The driver 310 may be integrated with a test management system 330 (e.g., SAP's Test Workbench), enabling a user to manage the automated testing of a multi-technology application. Such management functions may include test plan/package creation 332, where the user can configure the testing tools, test logic in the form of test scripts, test data parameters, and test settings to be used for the end-to-end test. The test scripts may correspond to scenarios in the end-to-end test. The user can add test tools and create his own test logic for use in the end-to-end test. The management functions also may include job scheduling/execution 334, where the user can configure the schedule for executing the selected test scripts. The management functions additionally may include performing an update 336 of the tested enterprise software package based on the knowledge of test results.

To begin the end-to-end test, the user may trigger the driver 310. The driver 310 may call N number of function modules based on the configured job schedule, where N can be any number. Each function module may correspond to one of the testing tools selected for the end-to-end test. For example, if the user has selected Selenium and QTP as the testing tools, then there will be one function module for Selenium and one function module for QTP. Having a separate function module for each automation tool provides a proper log-in mechanism for the process. The driver 310 may call the first function module, which has all of the import parameters for the respective test, such as the test script name, the path of the test script, and test data. The function module may establish a connection with the adapter 320 and trigger a request to execute a test using the corresponding testing tool and import parameters.

Each of the various function modules in the driver 310 may correspond to a different testing tool, and each function module may have an associated plug-in in adaptor 320. The adapter 320 may be configured to provide communication between the driver 310 and the testing tools to be used during the execution of the end-to-end test. The adapter 320 may be receive the test request and the import parameters from the driver 310, and then may associate the respective plug-in tool with the test request. For example, if the test request was triggered by a Selenium function module, then the adapter 320 invokes the Selenium plug-in tool. The adapter 320 may invoke the plug-in tool to execute the respective test on the client test machine.

The client test machine can be the local client machine on which the driver 310 and adapter 320 reside or a remote test client, such as one of the test clients 350-358, that is accessed via a network 340. Although FIG. 3 shows five remote test clients 350-358, it is contemplated that any number of remote test clients can be employed. In some embodiments, the driver 310 may provide the adapter 320 with information regarding the location of where the test is to be executed. For example, in some embodiments, the user may provide the driver 310 with the IP address of a particular test machine on which he desires the test to be executed. This IP address may be sent from the driver 310 to the adapter 320, where it is used to determine where to execute the test. In some embodiments, if the user does not identify which test machine is to be used, or if the identified test machine is not available, the adapter 320 may find an available test machine that is free for execution of the test. In some embodiments, the adapter 320 may ping a test client to find out if it is available.

The adapter 320 may invoke the plug-in testing tool and execute the test script on the client test machine. After the execution is completed, the test status and output data may be sent back to the adapter 320, and the adapter 320 may send the test status and the output data back to the driver 310. The driver 310 may then call the next scheduled function module, which may trigger the next test request in the end-to-end test. The received output data from the previous test execution can be passed to subsequent test executions for use as import parameters for the subsequent tests. This process flow may be repeated until all of the function modules and their respective tests have been executed. Once all of the scheduled tests have been executed, the driver 310 can provide a log of test results for the end-to-end test. These test results can then be analyzed by a user and used as a basis for updating the tested enterprise software package.

In some embodiments, extended Computer Aided Test Tool (eCATT) may be used as the driver 310. Drivers other than eCATT are also within the scope of the present embodiments. Additionally, the driver 310 can be used to test a back-end system 360. In some embodiments, the back-end system 360 may be an Advanced Business Application Programming (ABAP) back-end system. In some embodiments, back-end testing may be performed using the driver 310 as the testing tool, and front-end testing of the different products may be performed using respective testing tool plug-ins for the different technologies. It is contemplated that drivers other than an eCATT driver can be used and that back-end systems other than an ABAP back-end system can be tested. For example, a Java driver can be used to test an Oracle database.

The present disclosure describes a single client-based platform from which a user can test a multi-technology application and exchange data between testing tools. The driver 310, the adapter 320, and the plug-in testing tools may all be on the local client machine. The user does not need to maintain a server or database to manage all of the plug-in testing tools or their execution. Management of the testing tools may be performed on the local client machine.

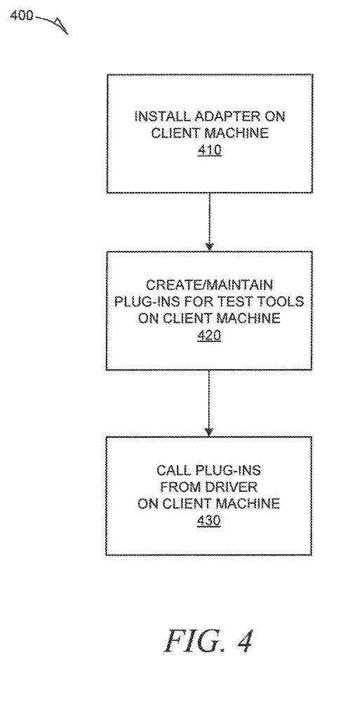

FIG. 4 is a flowchart illustrating an example embodiment of a method 400 for end-to-end test automation of a multi-technology application. At operation 410, the adapter may be installed on a local client machine from where the user triggers the execution of the tests. In some embodiments, a batch file may be downloaded on the local client machine, where it is run, thereby installing the adapter on the local client machine. In some embodiments, the batch file may set up a connection between the back-end system, the driver, and the adapter. In some embodiments, the adapter may be a .NET adapter.

At operation 420, the plug-ins for the testing tools may be created and maintained on the local client machine. The user can create his own testing tool plug-ins. The user can create a component assembly for whatever testing tool he wants to automate or call it as a unit. In some embodiments, templates for common testing tools are provided, thereby enabling the user to write his own test logic and maintain it on the local client machine. Each plug-in may correspond to one of the multiple technologies that make up the multi-technology application. For each technology used in the multi-technology application, an automation tool that can identify the objects of that particular technology is desirable. For example, if a multi-technology application includes HTMLS, then Selenium can be used as the testing tool to test this technology. Certain tools are best for certain technologies. In some embodiments, the creation of the plug-ins is based on how many technologies are used for a single multi-technology application.

At operation 430, the plug-ins may be called from the driver on the local client machine. The driver may trigger specific requests to the adapter. The adapter may communicate with, invoke, and exchanges data between the actual testing tools. Test data can be exchanged between function modules via parameterization. The adapter can pass output data from one plug-in tool to be used as input data for another plug-in tool. For example, in a use case for an end-to-end test that involves navigation in three different user interfaces, user interface 1 can be tested using eCATT, user interface 2 can be tested using Selenium, and user interface 3 can be tested using QTP. The output data from the eCATT tool can be used as input data for the Selenium tool, and the output data from the Selenium tool can be used as input data for the QTP tool in order to run the end-to-end test.

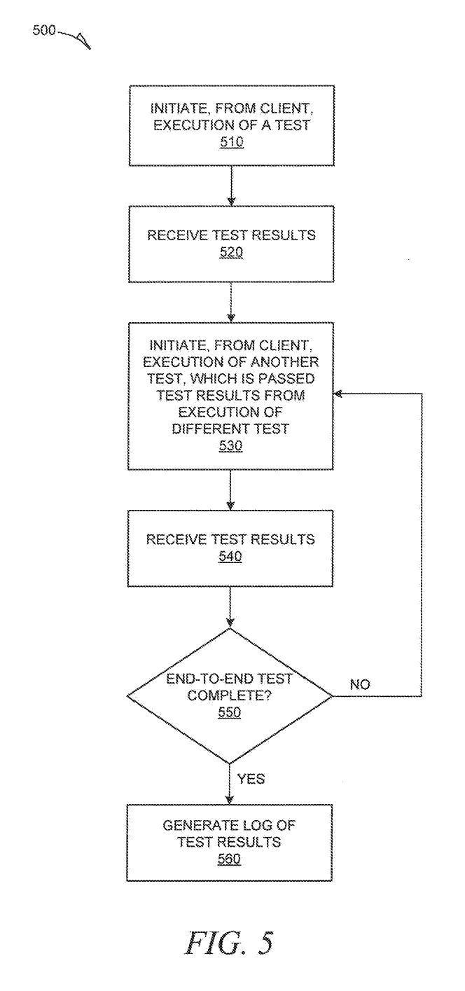

FIG. 5 is a flowchart illustrating an example embodiment of a method 500 for end-to-end testing of a multi-technology application.

At operation 510, the execution of the first test in the end-to-end testing is initiated from a client machine. As discussed above, this execution of the test can be triggered via the driver. All the testing information (e.g., test script, input data, etc.) can be copied from the driver to the test machine to be used in the execution of the test. At operation 520, the client machine receives the results of the test execution. At operation 530, the execution of another test is initiated from the client machine. Again, this execution of the test can be triggered by the driver and all the testing information can be copied to the test machine. Additionally, the test results from a different test (in this case, the first test) may be passed to this test and used in its execution. At operation 540, the client machine receives the test results of this test execution.

At operation 550, it is determined whether or not the end-to-end testing of the multi-technology application is complete. If the test is not complete, then the process returns to operation 530, where the execution of the next scheduled test is initiated, with test results from a different test being passed to and used by this current test, and then the test results are received by the client machine at operation 540. These operations are repeated until the end-to-end test is complete. When it is determined, at operation 550, that the end-to-end test is complete, at operation 560 a log of test results is generated by the client machine. This log of test results can then be presented to the user to determine if any update should be made.

The framework of the present embodiments can be used to test a variety of end-to-end scenario configurations. In one example embodiment, the test automation framework can be employed in an end-to-end test that involves the following stack:

1) mobile app. (platform dependent);

2) data service calls; and

3) ABAP back-end.

However, it is contemplated that other test scenario configurations are also within the scope of the present embodiments.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

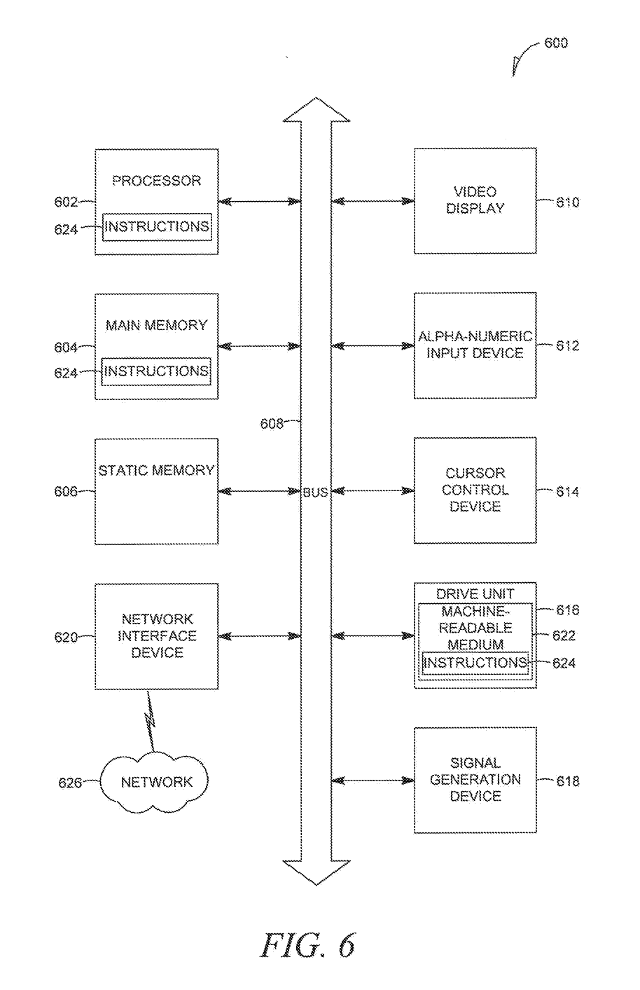

FIG. 6 is a block diagram of a machine in the example form of a computer system 600 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker) and a network interface device 620.

### Machine-Readable Medium

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
triggering, from a single platform on a local client machine, execution of a first test of a plurality of tests, each of the plurality of tests associated with a different testing tool, the execution of the plurality of tests together comprising an end-to-end automated testing of a multi-technology application;
receiving test result data from the execution of the first test;
triggering, from the single platform on the local client machine, execution of a second test of the plurality of tests;
passing test result data from the first test to the second test for use in the execution of the second test; and
generating a log of results for the end-to-end automated testing of the multi-technology application based on the end-to-end automated testing.

2. The method of claim 1, further comprising determining, from the local client machine, a testing tool from which to develop one of the plurality of tests.

3. The method of claim 1, further comprising creating, from the local client machine, test logic for use in execution of at least one of the plurality of tests.

4. The method of claim 1, wherein the execution of the plurality of tests is performed on the local client machine.

5. The method of claim 1, wherein the execution of the plurality of tests is performed on a remote client machine.

6. The method of claim 1, further comprising triggering, from the single platform on the local client machine, execution of a test on a back-end system.

7. The method of claim 6, wherein the back-end system is an ABAP back-end system.

8. The method of claim 1, wherein triggering the execution of first test comprises:
a driver on the client machine sending a test request to an adapter on the client machine, the test request corresponding to the first test;
the adapter determining a testing tool plug-in that corresponds to the first test; and
the adapter invoking the testing tool plug-in for use in the execution of the first test.

9. A system comprising:
a client machine having at least one processor; and
a framework operable on the client machine and configured to:
trigger, from a single platform on a local client machine, execution of a first test of a plurality of tests, each of the plurality of tests associated with a different testing tool, the execution of the plurality of tests together comprising an end-to-end automated testing of a multi-technology application;
receive test result data from the execution of the first test;
trigger, from the single platform on the local client machine, execution of a second test of the plurality of tests;
pass test result data from the first test to the second test for use in the execution of the second test; and
generate a log of results for the end-to-end automated testing of the multi-technology application based on the end-to-end automated testing.

10. The system of claim 9, wherein the framework is further configured to determine a testing tool from which to develop one of the plurality of tests.

11. The system of claim 9, wherein the framework is further configured to creating test logic for use in execution of at least one of the plurality of tests.

12. The system of claim 9, wherein the execution of the plurality of tests is performed on the local client machine.

13. The system of claim 9, wherein the execution of the plurality of tests is performed on a remote client machine.

14. The system of claim 9, wherein the framework is further configured to trigger execution of a test on a back-end system.

15. The system of claim 14, wherein the back-end system is an ABAP back-end system.

16. The system of claim 9, further comprising a driver on the client machine configured to send a test request to an adapter on the client machine, the test request corresponding to the first test, wherein the adapter is configured to determine a testing tool plug-in that corresponds to the first test, and to invoke the testing tool plug-in for use in the execution of the first test.

17. A non-transitory machine-readable storage device, tangibly embodying a set of instructions that, when executed by at least one processor, causes the at least one processor to perform operations comprising:
triggering, from a single platform on a local client machine, execution of a first test of a plurality of tests, each of the plurality of tests associated with a different testing tool, the execution of the plurality of tests together comprising an end-to-end automated testing of a multi-technology application;
receiving test result data from the execution of the first test;
triggering, from the single platform on the local client machine, execution of a second test of the plurality of tests;
passing test result data from the first test to the second test for use in the execution of the second test; and
generating a log of results for the end-to-end automated testing of the multi-technology application based on the end-to-end automated testing.

18. The machine-readable storage device of claim 17, wherein the operations further comprise determining, from the local client machine, a testing tool from which to develop one of the plurality of tests.

19. The machine-readable storage device of claim 17, wherein the operations further comprise creating, from the local client machine, test logic for use in execution of at least one of the plurality of tests.

20. The machine-readable storage device of claim 17, wherein the execution of the plurality of tests is performed on the local client machine.

21. The machine-readable storage device of claim 17, wherein the execution of the plurality of tests is performed on a remote client machine.

22. The machine-readable storage device of claim 17, wherein the operations further comprise triggering, from the single platform on the local client machine, execution of a test on a back-end system.

23. The machine-readable storage device of claim 17, wherein triggering the execution of the first test comprises:
a driver on the client machine sending a test request to an adapter on the client machine, the test request corresponding to the first test;
the adapter determining a testing tool plug-in that corresponds to the first test; and
the adapter invoking the testing tool plug-in for use in the execution of the first test.
